(19) United States
(12) Patent Application Publication
(10) Pub. No.: US 2015/0206220 A1
(43) Pub. Date: Jul. 23, 2015

(54) Recommendation Strategy Portfolios

(71) Applicant: Ecole Polytechnique Federale de Lausanne (EPFL), Lausanne (CH)

(72) Inventors: Claudiu-Christian Musat, Lausanne (CH); Boi Faltings, Preverenges (CH)

(73) Assignee: Ecole Polytechnique Federale de Lausanne (EPFL), Lausanne (CH)

(21) Appl. No.: 14/159,424

(22) Filed: Jan. 20, 2014

(51) Int. Cl. G06Q 30/06

(52) U.S. Cl. CPC G06Q 30/0631

(57) ABSTRACT

A recommender system comprising at least one computing device which comprises one or more processors and one or more computer-readable storage media operatively coupled to at least one of the processors, wherein said computing device performs a method of assigning a user to one group of a set of groups, said set of groups comprising at least two distinct groups, and a method of providing said user with at least one recommendation.

### FIELD OF THE INVENTION

The present invention concerns the field of recommender systems. The present invention relates in particular to a recommender system which performs a method of assigning a user to a group of a set of groups.

### BACKGROUND OF THE INVENTION

Nowadays, it has become a usual habit for numerous consumers around the world to purchase products or services via dedicated e-commerce, i.e. online selling, platforms. The number of such online platforms where products and services can be purchased (amazon, online grocery stores, etc.) has therefore exploded over the last twenty years. In some markets, these online platforms have become the favorite, if not the only, means for consumers to purchase products or services. Such online platforms are usually implemented by a distributed system. Such a system generally hosts a website that users connect to via an internet browser run on a personal computer, a smartphone, a pda or a tablet. Once connected to the website, users interact with the online platform and are in general able to submit information (user queries) and to retrieve information (query results). Alternatively, users can be provided with information even in the absence of a query, for instance by sending newsletters.

Moreover, in addition to providing users with the ability to browse and purchase items, some platforms, in particular those that include a so-called recommender system, allow users to be provided with so-called recommendations, i.e. purchasable items that are recommended to them. In the case of such online platforms that also include a recommender system, when a user, looking for a specific purchasable item, submits a query, the computing environment of the online platform is configured to execute automatically the recommender system which, in turn, automatically determines one or more additional purchasable items that are likely to match the user's personal interests. Then, in response to its query, the user is provided, together with the direct results to its submitted query, with those additional purchasable items which take the form of said recommendations. The user can then choose to select one or more of these recommendations determined by the recommender system for further conducting a purchasing process. Amazon® and Tripadvisor® are some of the most famous online platforms that include a recommender system. The recommendations can also be provided to users on the basis of the queries that the users have submitted in the past and they can be presented to users using, for instance, personalized newsletters.

Over the last few years, the importance of presenting accurate recommendations has thus shown to be an important aspect for online platforms. This aspect is indeed directly linked to the likelihood that a user will like or, in contrast, dislike an online platform. Therefore, having an efficient recommender system, in other terms a recommender system that is able to provide accurate recommendations to the users, is an aspect that must be carefully considered for enhancing purchasing experience and, consequently, customer satisfaction.

In order to provide recommendations to a user, a recommender system generally proceeds by analyzing a query submitted by the user. It then retrieves user related information, and, in accordance with one or more recommendation methods that it implements, it determines which purchasable items are likely to match the personal interests of the users.

The query can be either explicit, where the user is actively looking for a purchasable item that meets specific criteria or it can be implicit, derived from the behavior of the user. For instance, the user can be visiting a web page representing a purchasable product, which can be interpreted by the platform as an interest in products similar to the one that is viewed.

Moreover, when designing a recommender system, several approaches can be adopted.

One of these approaches consists in particular to design the recommender system in such a way that it implements one or more personalized recommendation methods. In a personalized recommendation method, recommendations provided to the users are computed in accordance with at least one property or one behavior of the users themselves. In this respect, user properties include, but are not limited to, the user's gender, age, marital status or social group. User behaviors are generally determined by collecting reviews or ratings previously submitted by the users.

These previously submitted reviews and ratings are analyzed by the recommender system and user profiles are determined based on this information. In certain situations, recommender systems implementing only personalized recommendation methods have been shown to be effective for providing users with accurate recommendations, in particular recommendations that efficiently match the users' interests.

However, although this approach is rather effective for some users, it turns out to be inefficient for other users. In particular, when reviews or ratings submitted by a user are not balanced, in other terms when reviews or ratings submitted by a user do not show both positive and negative clear-cut opinions, recommender systems implementing only personalized recommendation methods do not provide accurate results, in other terms such recommender systems are not able to provide useful recommendations to the said users.

The present invention intends to remedy to this drawback by providing an enhanced recommender system which is able to provide accurate recommendations for all types of users.

### SUMMARY OF THE INVENTION

A recommender system according to a preferred embodiment of the invention comprises at least one computing device which comprises one or more processors and one or more computer-readable storage media operatively coupled to at least one of the processors, wherein said computing device performs a method of assigning a user to one group of a set of groups, said set of groups comprising at least two distinct groups, and a method of providing said user with at least one recommendation, wherein said method of assigning a user to one group of a set of groups comprises the steps of:
collecting personal information about said user;
computing a profile for said user, said profile containing one or more user values, each one of said one or more user values corresponding to one respective predefined parameter of a set of predefined parameters, wherein said set of predefined parameters includes one or more user's opinion distribution related parameters and wherein said one or more user values include one or more user's opinion distribution related values;
determining a preferred group for said user on the basis of said profile for said user; and
assigning said user to said preferred group;
   and wherein said method of providing said user with at least one recommendation comprises the steps of:
retrieving a recommendation portfolio, said recommendation portfolio containing two or more recommendation methods;
retrieving the preferred group to which said user is assigned;
selecting, in accordance with said preferred group, n recommendation methods within the recommendation portfolio, wherein n is an integer equal or superior to 1 and strictly inferior to the number of recommendation methods contained in the recommendation portfolio;
using said selected recommendation methods to determine purchasable product rankings for said user; and
providing said user with said at least one recommendation based on said purchasable product rankings.

According to the invention, said step of determining a preferred group for said user may include a step of comparing said one or more user values with one or more predefined thresholds.

According to the invention, at least one of said one or more user's opinion distribution related parameters may relate to the content of reviews previously submitted by said user.

According to the invention, at least one of said one or more user's opinion distribution related parameters may relate to ratings previously posted by said user.

According to the invention, said step of determining a preferred group for said user may be performed by a machine learning module implemented by said computing device.

According to the invention, said step of selecting, in accordance with said preferred group, n recommendation methods within the recommendation portfolio may further comprise a step of determining a most accurate recommendation method associated with said preferred group.

According to the invention, said step of providing said user with said at least one recommendation may further comprise a step of using said most accurate recommendation method to compute said at least one recommendation.

According to the invention, said step of selecting, in accordance with said preferred group, n recommendation methods within the recommendation portfolio may further comprise a step of determining one or more applicable recommendation methods associated with said preferred group.

According to the invention, said step of providing said user with said at least one recommendation may further comprise a step of assigning a weight parameter to each one of said one or more applicable recommendation methods.

According to the invention, said step of retrieving a recommendation portfolio may further comprise a step of executing a first software application to query a first database in which said recommendation portfolio is stored, said first database being stored on a first server connected to said computing device via a communication network.

According to the invention, said recommendation methods may be selected from the group consisting of personalized recommendation methods and non-personalized recommendation methods.

According to the invention, said personalized recommendation methods may be selected from the group consisting of collaborative filtering methods, content-based methods, knowledge-based methods, demographic-based methods and critique-based methods.

According to the invention, said non-personalized methods may be selected from the group consisting of cheapest item retrieval method, most popular item retrieval method and best rated item retrieval method.

According to the invention, said step of providing said user with at least one recommendation may further comprise a step of applying a personalized recommendation method to compute said at least one recommendation.

According to the invention, said step of providing said user with at least one recommendation may further comprise a step of applying a non-personalized recommendation method to compute said at least one recommendation.

According to the invention, said step of assigning said user to said preferred group may further comprise a step of storing a group parameter in said profile for said user.

According to the invention, said step of collecting personal information about said user further may comprise a step of executing a second software application to query a second database in order to retrieve a first part of said user information, said second database being stored on a second server connected to said computing device via a communication network.

According to the invention, said step of computing a profile for said user may further comprise a step of determining if a known user profile exists for said user.

A recommender system according to another embodiment of the invention comprises at least a first and a second computing device, which both comprise one or more processors and one or more computer-readable storage media operatively coupled to at least one of the processors, wherein said first computing device performs a method of assigning a user to one group of a set of groups, said set of groups comprising at least two distinct groups, and wherein said second computing device performs a method of providing said user with at least one recommendation, wherein said method of assigning a user to one group of a set of groups comprises the steps of:
collecting personal information about said user;
computing a profile for said user, said profile containing one or more user values, each one of said one or more user values corresponding to one respective predefined parameter of a set of predefined parameters, wherein said set of predefined parameters includes one or more user's opinion distribution related parameters and wherein said one or more user values include one or more user's opinion distribution related values;
determining a preferred group for said user on the basis of said profile for said user; and
assigning said user to said preferred group;
   and wherein said method of providing said user with at least one recommendation comprises the steps of:
retrieving a recommendation portfolio, said recommendation portfolio containing two or more recommendation methods;
retrieving the preferred group to which said user is assigned;
selecting, in accordance with said preferred group, n recommendation methods within the recommendation portfolio, wherein n is an integer equal or superior to 1 and strictly inferior to the number of recommendation methods contained in the recommendation portfolio;
using said selected recommendation methods to determine purchasable product rankings for said user; and
providing said user with said at least one recommendation based on said purchasable product rankings.

### BRIEF DESCRIPTION OF THE DRAWINGS

Other advantages and features of the invention will become more clearly apparent from the following description of the invention which refers to the accompanying drawings, in which:

FIG. 1 diagrammatically represents the methods performed by the recommender system in accordance with the present invention;

FIG. 2 diagrammatically represents a method of separating users known to the recommender system into groups that may be performed by the recommender system in accordance with the present invention.

### DETAILED DESCRIPTION

The recommender system of the present invention comprises one or more servers and one or more databases stored on said one or more servers. Said one or more servers are connected together via one or more communication networks and each one of said one or more servers includes one or more pieces of hardware and one or more pieces software, said pieces being designed, respectively programmed, in such a way that they perform an intended function. In particular, each one of said one or more servers includes one or more processors and one or more computer-readable storage media coupled to said one or more processors. The recommender system of the present invention is further connected, through one or more communication networks, to an online computing environment that implements an online platform which includes one or more websites with their related components and which can be accessed by users through a web browser run on a personal computing device connected to internet, for instance a personal computer, a Smartphone, a tablet, etc.

The servers of the recommender system of the present invention perform several methods. Preferably, at least one of the servers of the recommender system of the present invention performs a method of a assigning a user to one group of a set of groups and a method of providing a user with at least one recommendation. Those methods, which will be described below, allow a user, first, to be assigned to one group and this group assignment is used to determine at least one accurate recommendation to be provided to said user.

In the sense of the present invention, the set of groups comprises at least two distinct groups to which users may be assigned, in accordance, as will be described below, with specific criteria. In the sense of the present invention, a group has to be seen as a set of users which share common characteristics. Following the execution of the steps of the method of assigning a user to one group of a set of groups, the recommender system in accordance with the present invention is able to provide accurate recommendations for all types of users.

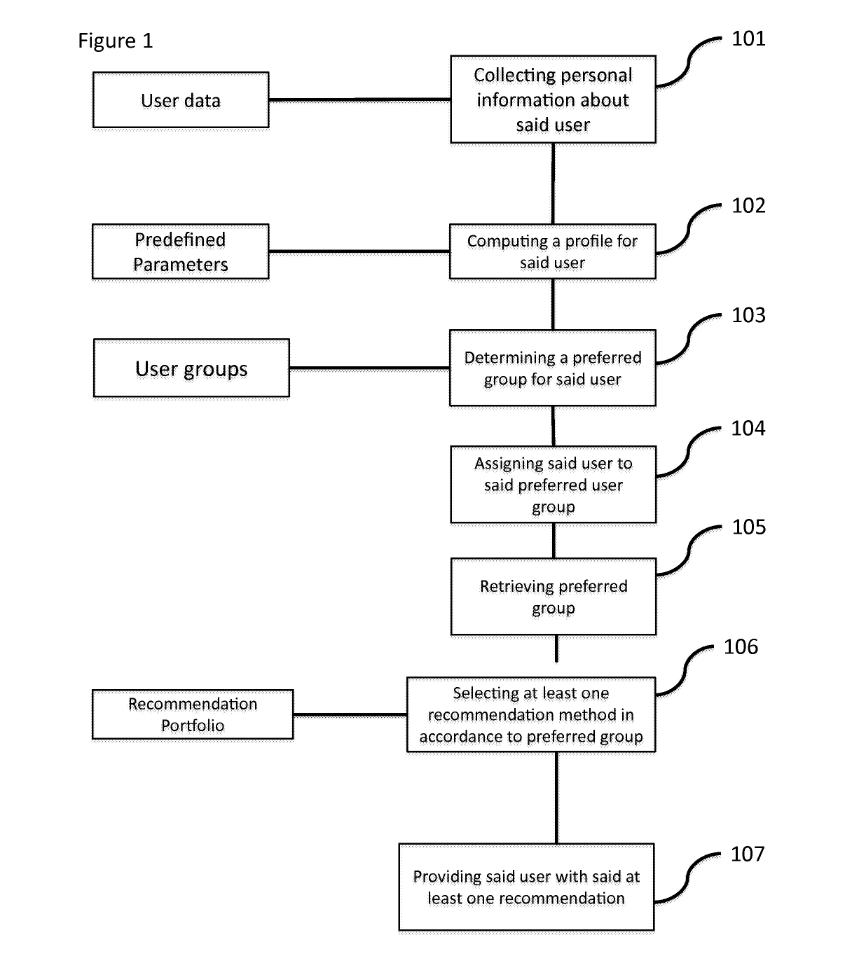

FIG. 1 diagrammatically represents some of the methods performed, preferably, by at least one of the servers of the recommender system in accordance with the present invention, in particular the method of assigning a user to one group of a set of groups and the method of providing a user with at least one recommendation.

In a step 101, when a user starts to interact with the online platform, i.e. when a user connects via a personal computing device to one of the websites of the online platform, personal information in relation with the user is collected. This personal information may be deduced from a query submitted by the user but, alternatively or jointly, this information can also be aggregated with other information extracted from a database stored on one of the servers of the recommender system.

Such extraction step happens in particular in the case where the user is already known by the online platform, the recommender system or both of them, in other terms if the user has already been interacting in the past with the online platform, the recommender or both of them. In this case, a so-called “known user profile” may exist and the recommender system, respectively the online platform, will, following the submission of the query, determine if such “known user profile” is available and extract it. In such a case, the step 101 of collecting personal information thus includes a step of retrieving said “known user profile” from a database of the online platform or of the recommender system.

The step 101 of collecting personal information about said user may further include a step of collecting implicit data.

The step of collecting implicit data may include a step of analyzing the user's online browsing history, a step of determining its purchasing habits and a step of retrieving its social network public memberships. Implicit data may also include information derived from reviews previously submitted by the user, ratings previously posted, etc. Implicit data may further include information derived from the query submitted by the user. The step of collecting implicit data may thus include a step of analyzing the submitted query and a step of retrieving and analyzing previously submitted reviews and/or previously posted ratings.

The step 101 of collecting personal information about said user may also include a step of collecting explicit data.

Explicit data is gathered by providing the user with questionnaires, surveys or polls that allow users to be directly asked about their personal needs and interests but also about more generic information such as the location, the gender, the marital status, etc.

The personal information which is collected can thus include information such as the gender of the user, his age, his location, his IP address, the type of browser or operating system he is using, his GPS location, etc. In addition, personal information can also include information related to the user's past behavior, for instance reviews previously submitted, ratings previously posted, etc.

In the step 101, all the available personal information about the user who interacts with the online platform is aggregated. This aggregating step can further include a step of semantic analyses of reviews previously submitted by the user or computations performed on the basis of ratings previously posted.

In addition, the step 101 of collecting personal information about the said user may also include a step of storing said personal information in one or more databases stored on one or more servers of the recommender system.

In a further step 102, a user profile is computed for the user. The user profile is computed in accordance with the personal information collected at step 101 and includes a step of retrieving a set of predefined parameters which are recorded in a database stored on one of the servers of the recommender system.

The set of predefined parameters necessarily includes at least one parameter, it necessarily includes at least one user's opinion distribution related parameter, it may include one or more parameters that relate to a submitted query and one or more parameters that relate to the user.

A user's opinion distribution related parameters relates to and defines the distribution of the opinions that can be derived from the content, for instance the text or video, of the reviews that have been previously submitted by the user. Similarly, a user's opinion distribution related parameter relates to and defines the distribution of the numeric ratings that have been previously posted by the user. The opinions can for instance be derived using a variety of methods known as opinion mining.

A user's opinion distribution related parameter may be a parameter that relates to and defines the fact that opinions that can be derived from the content of reviews previously submitted by the user are balanced or unbalanced, in other terms whether previously submitted reviews can show both positive and negative clear-cut opinions or not. One clear-cut opinion is either unambiguously positive or unambiguously negative.

A user's opinion distribution related parameter may be a parameter that relates to and defines the fact that numeric ratings posted by the user are balanced or unbalanced, in other terms if the numeric ratings previously posted by the user show both positive and negative clear-cut opinions. Numeric ratings with high values, for instance 4 and 5 on a scale from 1 to 5, are typically associated with positive opinions, while numeric ratings with low values, for instance 1 and 2 on a scale from 1 to 5 are typically associated with negative opinions.

A user's opinion distribution related parameter may also be a parameter that relates to and defines the ratio of positive to negative opinions either for the entire content or for specific aspects within the content of previously submitted reviews. Similarly, a user's opinion distribution related parameter may be a parameter that relates to and defines the ratio of positive to negative previously posted numeric ratings.

Submitted query related parameters are parameters that relate to and define some aspects of a query that has been submitted by the user. Submitted query related parameters may relate to the type of purchasable item that the user was looking for at some point in the past, such as for example objects, hotels, restaurants, car rentals, computer hardware/software, etc.

User related parameters are parameters that relate to and define characteristics of the user that has submitted the query. These parameters can thus include one or more location related parameters, one or more demographic related parameters (gender, age, marital status, etc.), etc.

The step 102 of computing the profile for said user comprises at least a step of allocating a user value to each predefined parameter contained in the set of predefined parameters. In this respect, personal information collected at step 101 is projected onto the set of predefined parameters. In other terms, each piece of personal information is analyzed and used for allocating a user value to one or more predefined parameters. For example, with respect to a predefined parameter that relates to, and defines, the balanced character of reviews, the reviews previously submitted by the user are analyzed and used to determine whether the opinions within these reviews are balanced or unbalanced. A corresponding user value is then computed in accordance with this analysis. This user value is included in the profile of the user. This process of affecting and recording a user value is conducted for each predefined parameter. At the end of execution of step 102 of computing a profile for said user, the profile for said user generally contains one user value for each predefined parameter contained in the set of predefined parameters.

It can however happen that it is not possible to determine one or more user values with respect to one or more predefined parameters. In this case a specific user value, for example a “N/A” value or an “∞” (infinite) value, can still be affected and stored in the user profile to indicate that it is not possible to determine a user value for the corresponding predefined parameter.

Once the profile for said user is computed at step 102, a step 103 of determining a preferred group for said user is performed. A preferred group is determined on the basis of said one or more user values computed at step 102 and recorded in the profile for said user. As it will be understood by those skilled in the art, a user is thus assigned to a group based on information that is directly related to him, with the similarity computed based on the user values within the user profiles.

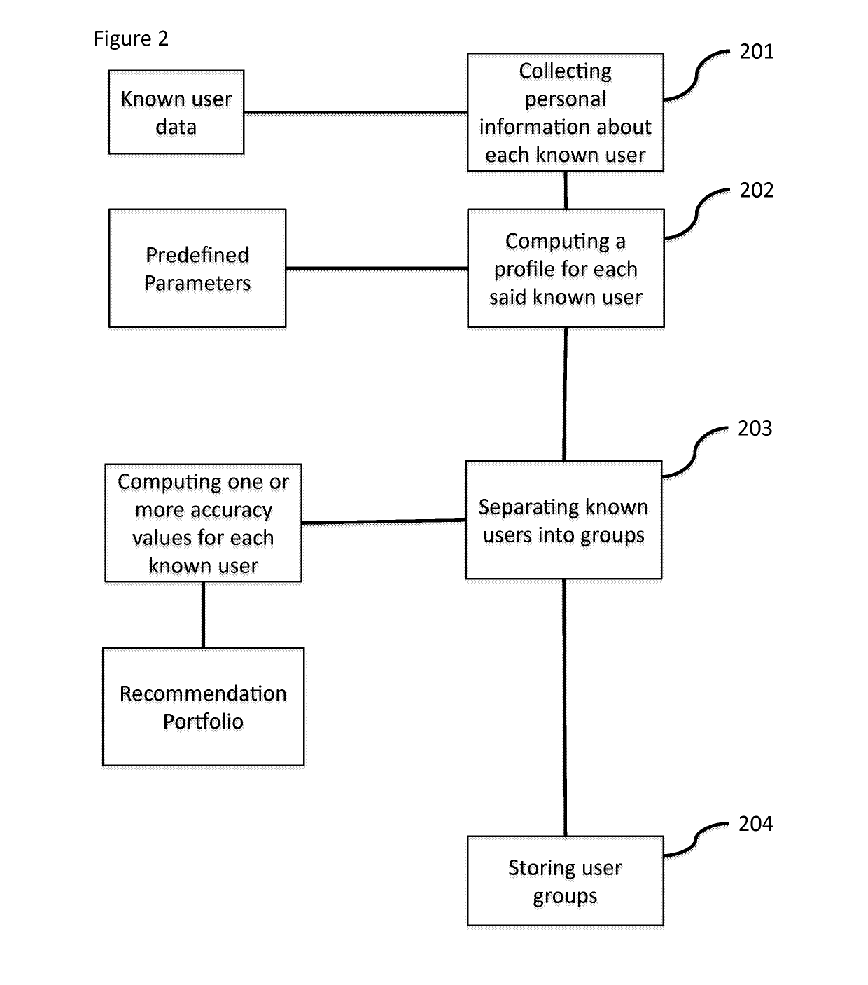

The groups of users are created beforehand. For instance, they may be created using a method of separating users known to the recommender system into groups, which is described below, in according with FIG. 2. Said groups may also be created using a method which comprises at least one step of comparing one or more of said user values with predefined thresholds. By comparing one or more of said one or more user values with predefined thresholds, a group may be defined as, for instance, users whose opinions derived from the content of reviews previously posted are balanced.

The step 103 of determining the preferred group for said user can be performed by making use of an automated module, implemented by at least one of the servers of the recommender system of the present invention. The role of such an automated module is to output a preferred group in accordance with the data it receives as input, in particular in accordance with the user values and parameters related to the groups of users. The module may use decision trees based algorithms, clustering algorithms, neural networks or any other type of artificial intelligence algorithms well known to those skilled in the art.

However, step 103 can alternatively be performed by a set of human judges who receive user values and group related parameters and determine, based on this information, to which preferred group a user has to be assigned.

Once the preferred group has been determined at step 103, a step 104 of assigning the user to the determined preferred group is performed. This assignment may include a step of storing a group parameter in the user profile or a step of storing user identification related parameter in a data set that relates and/or defines the preferred group.

The steps 101-104 described above are the main steps that are included in the method of assigning a user to one group of a set of groups. As described above, this method is performed by at last one of the servers of the recommender system. Preferably, it is the same server that performs a method of providing said user with at least one recommendation that will be described below. Alternatively, it is another server of the recommender system that performs the method of providing said user with at least one recommendation. Alternatively, each one of the steps of both methods is performed a distinct server of the recommender system.

The method of providing said user with at least one recommendation starts with a step 105 of retrieving the preferred group to which the user is assigned.

Then, the method of providing said user with at least one recommendation includes a step 106 of selecting, in accordance with the preferred group retrieved at step 105, n recommendation methods to be executed.

In this respect, the step 106 may further include a step of executing a software application, run on at least one of the servers of the recommender system of the present invention, to retrieve a recommendation portfolio.

The recommendation portfolio contains a set of two or more recommendation methods, each one of said recommendation method being able to compute one or more recommendations on the basis of input data fed to it. Recommendation methods stored in the recommendation portfolio can be of a personalized type, so called personalized recommendation methods, or of a non-personalized type, so called non-personalized recommendation methods.

Non-personalized recommendation methods may provide recommendations by retrieving most popular items, cheapest items, best rated items, etc.

In contrast, personalized recommendation methods may provide recommendations by making use of several methods such as collaborative filtering methods, content-based methods, knowledge-based methods, demographic-based methods, critique-based methods, etc.

The number n of selected recommendation methods is an integer which is equal or superior to 1 and strictly inferior to the total number of recommendation methods contained in the recommendation portfolio that is described below.

The step 106 may further include a first step of determining a most accurate recommendation method which is associated with said preferred group retrieved at step 105. This is in particular the case when only one recommendation method provides accurate recommendations for a given group.

Alternatively, the step 106 may include a step of determining one or more applicable recommendation methods associated with said preferred group. This is in particular the case when several recommendation methods are suitable for providing accurate recommendations for a given group.

Then, the one or more recommendation methods that have been selected are used to determine rankings of purchasable products.

A step 107 of providing the user with said at least one recommendation, based on the product rankings that have been determined for each selected recommendation method at step 106, is then performed. If necessary, purchasable products rankings associated with each recommendation method selected in step 106 may be combined using one of a plurality of voting mechanisms, for instance as Borda counts.

In the case when only one recommendation method provides accurate recommendations for a given group, the step 107 of providing the user with said at least one recommendation includes a step of making use of said most accurate recommendation method to compute said at least one recommendation, i.e. one or more recommendations, that is then provided to the user that has submitted the query.

In the case when several recommendation methods are suitable for providing accurate recommendations for a given group, the step 107 of providing the user with said at least one recommendation may include a step of assigning a weight parameter to each one of the applicable recommendation methods and a step of computing one or more recommendations to be provided to said user by making use of at least one of the applicable recommendation methods, preferably in accordance with the weight parameters that have been assigned to each one of them. The weight parameters can be distinct or not.

As can be understood from the previous explanations, the recommender system of the present invention is able to determine which recommendation method is, or are, likely to provide accurate recommendations for a given user, by computing the best recommendation methods and method combinations for each one of a plurality of user groups and assigning the given user to one of the plurality of groups.

As such, the recommender system of the present invention is able to provide accurate results, i.e. recommendations, for any type of user. The recommender system of the present invention is in particular able to provide accurate recommendations for user that have submitted reviews in the past, based on which one can determine whether or not they are balanced, in other terms reviews based on which one can determine whether or not the user offers clear-cut opinions on purchasable products.

Preferably, the sequence of steps 101-107 is performed in a successive way as described above by one or several servers of the recommender system. However, alternatively, steps 101-107 can all be performed at the same time. It is furthermore also possible that some of the steps are performed periodically or continuously at different points in time independently from the others.

FIG. 2 diagrammatically represents a method of separating users known to the recommender system into groups that may be performed by at least one of the servers of the recommender system in accordance with the present invention. As stated above, this method of separating users known to the recommender system is only one of the possible methods that may be used for creating the groups.

In a step 201, for each known user of a subset of known users, personal information is extracted from a database stored on one of the servers of the recommender system.

The step 201 of collecting personal information about each known user may further include a step of collecting implicit data about each known user. The step of collecting implicit data may also include a step of aggregating information derived from the said known user's submitted data, such as reviews previously submitted, ratings previously posted, etc.

The step of collecting implicit data may thus include a step of analyzing the submitted queries and a step of retrieving and analyzing reviews that the known users have previously posted and ratings that they have previously posted.

The step 201 of collecting personal information about each said known user may also include a step of collecting explicit data about each said known user.

In the step 201, all the available personal information regarding each said known user is aggregated. This aggregating step can further include a step of semantic analyses of reviews previously submitted by each said known user or computations performed on the basis of ratings previously posted.

In addition, step 201 of collecting personal information about each said known user may also include a step of storing said personal information in one or more databases stored on one or more servers of the recommender system.

In a step 202, a so-called “known user profile” is computed, based on the personal information aggregated in step 201, and includes a step of retrieving the set of predefined parameters which, as described in relation to FIG. 1, is recorded in a database stored on one of the servers of the recommender system.

The step 202 of computing the profile for each said known user comprises at least a step of allocating a user value to each predefined parameter contained in the set of predefined parameters. In this respect, personal information collected at step 201 is projected onto the set of predefined parameters. In other terms, each piece of personal information is analyzed and used for creating a user value to one or more predefined parameters. This process of affecting and recording a user value is conducted for each predefined parameter. At the end of execution of step 202 of computing a profile for each said known user, the profile for each said known user generally contains one user value for each predefined parameter contained in the set of predefined parameters.

As described in relation with FIG. 1 with respect to the step of computing a profile for said user, it can however happen that it is not possible to determine one or more user values with respect to one or more predefined parameters. In this case a specific user value, for example a “N/A” value or an “o” (infinite) value, can still be affected and stored in the user profile to indicate that it is not possible to determine a user value for the corresponding predefined parameter.

Once the profile for each said known user is computed at step 202, the recommender system performs a step 203 of separating said known users into groups.

The step 203 of separating said known users into groups may further include a step which consists in computing, for each said known user, one or more accuracy values for one or more recommendation methods contained in the recommendation portfolio as described in relation with FIG. 1.

In this respect, the step 203 may further include a step of executing a software application, run on at least one of the servers of the recommender system of the present invention, to retrieve the recommendation portfolio.

For each recommendation method contained in the portfolio of recommendation methods, an accuracy value is computed on the basis of the user values contained in the profile for said known user. Alternatively, the accuracy value is computed on the basis of the personal information that has been collected at step 201. Alternatively, the accuracy value is computed on the basis of the user values contained in the profile for said known user and on the basis of the personal information that has been collected at step 201.

An accuracy value defines the accuracy of a recommendation method for the said known user. In other terms, the accuracy value defines whether the recommendation method for which it is computed is able to provide an accurate recommendation for the user. An accuracy value can take a zero value when the corresponding recommendation method is not able to provide an accurate recommendation and a positive value otherwise. Other choice of different accuracy values (Boolean, only integers, ordinal, etc.) may also be used.

Thus, once the step of computing one or more accuracy values has been performed, one accuracy value is, preferably, computed for each recommendation method contained in the portfolio of recommendation methods. Alternatively, it can be decided to configure the recommender system of the present invention in such a way that accuracy values are only computed for some of the recommendation methods contained in the recommendation portfolio but not for all of them.

Thus, after the execution of the step consisting of computing one or more accuracy values, the recommender system of the present invention is at least able to establish, with respect to each known preference of each said known user, a ranking of one or more of the recommendation methods contained in the recommendation portfolio.

In the scope of the present invention, a group contains known users from the said known users, for whom recommendation methods from the said recommendation portfolio yield similar results and are similar with respect to the parameter values within their respective user profiles. For instance, given the users' opinion distribution parameter values, a personalized recommendation method may be found to have higher accuracy values for users who have expressed balanced opinions in previously submitted reviews of previously posted ratings.

In contrast, a non-personalized recommendation method may be found to have higher accuracy values for users who have not expressed balanced opinions in previously submitted reviews of previously posted ratings. In this case, the users may be separated into two groups, given the said accuracy values of the said personalized and non-personalized methods, a first group containing users who have expressed balanced opinions in previously submitted reviews of previously posted ratings and a second group containing users who have not expressed balanced opinions in previously submitted reviews of previously posted ratings.

A group thus necessarily contains at least one user. Moreover, a group in the sense of the present invention does not contain all the users of the recommender system, in other terms the maximum number of users contained in a group is thus strictly inferior to the maximum number of known users.

The groups are created using the accuracy values of the recommendation methods within a recommendation portfolio, by means of either machine learning or human judges or a combination thereof.

The step 203 of separating the said known users into groups can be performed by making use of a machine learning module implemented by at least one of the servers of the recommender system of the present invention. The role of such machine learning module is to create groups for known users in accordance with the data it receives as input, in particular in accordance with the said known user profile values and the recommendation method accuracy values for each known user. The machine learning module may use decision trees based algorithms, clustering algorithms, neural networks or any other type of artificial intelligence algorithms well known to those skilled in the art.

Step 203 can alternatively be performed by a set of human judges who receive said known user values and corresponding recommendation method accuracy values and determine, based on this information, the number of groups and assign the said known users to said groups.

Once the preferred groups have been determined at step 203, at least one of the servers of the recommender system of the present invention performs a step 204 of storing the user groups. This assignment may include a step of storing a group parameter in the said known user profiles or a step or storing, for the said known users, user identification related parameter in a data set that relates and/or defines the preferred group. Alternatively, at least one of the servers of the recommender system can perform a step of storing a classifier for users, said classifier using the values stored in the said users' profiles to separate them into user groups. A classifier can further perform a step of comparing one or more values in the user profiles with predetermined parameters. For instance, a classifier can classify users who have expressed balanced opinions in previously submitted reviews into a first group and users who have not expressed balanced opinions in previously submitted reviews into a second group.

What is claimed is:

1. A recommender system comprising at least one computing device which comprises one or more processors and one or more computer-readable storage media operatively coupled to at least one of the processors, wherein said computing device performs a method of assigning a user to one group of a set of groups, said set of groups comprising at least two distinct groups, and a method of providing said user with at least one recommendation, wherein said method of assigning a user to one group of a set of groups comprises the steps of:
collecting personal information about said user;
computing a profile for said user, said profile containing one or more user values, each one of said one or more user values corresponding to one respective predefined parameter of a set of predefined parameters, wherein said set of predefined parameters includes one or more user's opinion distribution related parameters and wherein said one or more user values include one or more user's opinion distribution related values;
determining a preferred group for said user on the basis of said profile for said user; and
assigning said user to said preferred group;
and wherein said method of providing said user with at least one recommendation comprises the steps of:
retrieving a recommendation portfolio, said recommendation portfolio containing two or more recommendation methods;
retrieving the preferred group to which said user is assigned;
selecting, in accordance with said preferred group, n recommendation methods within the recommendation portfolio, wherein n is an integer equal or superior to 1 and strictly inferior to the number of recommendation methods contained in the recommendation portfolio;
using said selected recommendation methods to determine purchasable product rankings for said user; and
providing said user with said at least one recommendation based on said purchasable product rankings.

2. The recommender system of claim 1, wherein said step of determining a preferred group for said user includes a step of comparing said one or more user values with one or more predefined thresholds.

3. The recommender system of claim 1, wherein at least one of said one or more user's opinion distribution related parameters relates to the content of reviews previously submitted by said user.

4. The recommender system of claim 1, wherein at least one of said one or more user's opinion distribution related parameters relates to ratings previously posted by said user.

5. The recommender system of claim 1, wherein said step of determining a preferred group for said user is performed by a machine learning module implemented by said computing device.

6. The recommender system of claim 1, wherein said step of selecting, in accordance with said preferred group, n recommendation methods within the recommendation portfolio further comprises a step of determining a most accurate recommendation method associated with said preferred group.

7. The recommender system of claim 6, wherein said step of providing said user with said at least one recommendation further comprises a step of using said most accurate recommendation method to compute said at least one recommendation.

8. The recommender system of claim 1, wherein said step of selecting, in accordance with said preferred group, n recommendation methods within the recommendation portfolio further comprises a step of determining one or more applicable recommendation methods associated with said preferred group.

9. The recommender system of claim 8, wherein said step of providing said user with said at least one recommendation further comprises a step of assigning a weight parameter to each one of said one or more applicable recommendation methods.

10. The recommender system of claim 1, wherein said step of retrieving a recommendation portfolio further comprises a step of executing a first software application to query a first database in which said recommendation portfolio is stored, said first database being stored on a first server connected to said computing device via a communication network.

11. The recommender system of claim 1, wherein said recommendation methods are selected from the group consisting of personalized recommendation methods and non-personalized recommendation methods.

12. The recommender system of claim 11, wherein said personalized recommendation methods are selected from the group consisting of collaborative filtering methods, content-based methods, knowledge-based methods, demographic-based methods and critique-based methods.

13. The recommender system of claim 11, wherein said non-personalized methods are selected from the group consisting of cheapest item retrieval method, most popular item retrieval method and best rated item retrieval method.

14. The recommender system of claim 1, wherein said step of providing said user with at least one recommendation further comprises a step of applying a personalized recommendation method to compute said at least one recommendation.

15. The recommender system of claim 1, wherein said step of providing said user with at least one recommendation further comprises a step of applying a non-personalized recommendation method to compute said at least one recommendation.

16. The recommender system of claim 1, wherein said step of assigning said user to said preferred group further comprises a step of storing a group parameter in said profile for said user.

17. The recommender system of claim 1, wherein said step of collecting personal information about said user further comprises a step of executing a second software application to query a second database in order to retrieve a first part of said user information, said second database being stored on a second server connected to said computing device via a communication network.

18. The recommender system of claim 1, wherein said step of computing a profile for said user further comprises a step of determining if a known user profile exists for said user.

19. A recommender system comprising at least a first and a second computing device which both comprise one or more processors and one or more computer-readable storage media operatively coupled to at least one of the processors, wherein said first computing device performs a method of assigning a user to one group of a set of groups, said set of groups comprising at least two distinct groups, and wherein said second computing device performs a method of providing said user with at least one recommendation, wherein said method of assigning a user to one group of a set of groups comprises the steps of:
collecting personal information about said user;
computing a profile for said user, said profile containing one or more user values, each one of said one or more user values corresponding to one respective predefined parameter of a set of predefined parameters, wherein said set of predefined parameters includes one or more user's opinion distribution related parameters and wherein said one or more user values include one or more user's opinion distribution related values;
determining a preferred group for said user on the basis of said profile for said user; and
assigning said user to said preferred group;
and wherein said method of providing said user with at least one recommendation comprises the steps of:
retrieving a recommendation portfolio, said recommendation portfolio containing two or more recommendation methods;
retrieving the preferred group to which said user is assigned;
selecting, in accordance with said preferred group, n recommendation methods within the recommendation portfolio, wherein n is an integer equal or superior to 1 and strictly inferior to the number of recommendation methods contained in the recommendation portfolio;
using said selected recommendation methods to determine purchasable product rankings for said user; and
providing said user with said at least one recommendation based on said purchasable product rankings.
